(19) United States
(12) Patent Application Publication
(10) Pub. No.: US 2009/0063163 A1
(43) Pub. Date: Mar. 5, 2009

(54) METHOD AND APPARATUS FOR ENCODING/DECODING MEDIA SIGNAL

(75) Inventors: Jong-hoon JEONG, Suwon-si (KR); Geon-hyoung LEE, Hwaseong-si (KR); Nam-suk LEE, Suwon-si (KR); Jae-one OH, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/186,128

(22) Filed: Aug. 5, 2008

(30) Foreign Application Priority Data
Aug. 31, 2007 (KR) 10-2007-0088301

(51) Int. Cl. G10L 19/00

(52) U.S. Cl. 704/500; 704/E19.001

(57) ABSTRACT

Provided are a method and apparatus for encoding/decoding a media signal. The method of encoding a media signal includes: when harmonics exist in a sinusoid of a previous frame section, predicting a harmonic frequency of a current frame section that is to be encoded by using a harmonic frequency of the previous frame section, and generating a residual signal by using a difference between the predicted frequency and an actual harmonic frequency of the current frame section.

### CROSS-REFERENCE TO RELATED PATENT APPLICATION

This application claims the benefit of Korean Patent Application No. 10-2007-0088301, filed on Aug. 31, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding a multimedia signal, and more particularly, to a method and apparatus for encoding/decoding a multimedia signal, which can efficiently encode and decode a multimedia signal by using a harmonic property.

2. Description of the Related Art

While transmitting a media signal, a compression technology is used in order to reduce a bandwidth or a bit rate of the media signal. According to a parametric encoding method, a media signal is divided into component signals, which have certain properties, and a parameter, which shows a property of the divided component signal, is encoded. A parametric encoding apparatus divides a media signal into segments or frames, and assumes that each frame of the media signal is formed of a transient component, a sinusoidal component, and a noise component. The parametric encoding apparatus decomposes the media signal into each component, and quantizes and encodes each decomposed component. However, at this time, data that is the same is repeatedly encoded even when there is a plurality of frames including similar components, and thus such a process is inefficient. Also, while generating and transmitting a media signal, distortion, such as modification of the media signal due to a reiteration of media signals, may occur, and thus the efficiency of encoding/decoding the media signal may deteriorate.

### SUMMARY OF THE INVENTION

The present invention provides a method and apparatus for encoding/decoding a media signal, in which signal fidelity can be improved by minimizing distortion of the media signal, by parameterizing and transmitting a changed component in consideration of a signal change between frames according to a change of time.

The present invention also provides a method and apparatus for encoding/decoding a media signal, which can improve compression efficiency by predicting harmonics of a current frame section by using harmonics of an adjacent frame section based on a characteristic that similarities between adjacent frames of the media signal is high, and when a prediction result error occurs, compressing a compensation value of the prediction result error.

The present invention also provides a method and low capacity apparatus for encoding/decoding a media signal, which can encode/decode a media signal with low capacity by encoding a difference between harmonics of a certain frame section and an adjacent frame section, without encoding all harmonics of the certain frame section of the media signal.

According to an aspect of the present invention, there is provided a method of encoding a media signal comprising a plurality of frames, the method including: when harmonics exist in a sinusoid of a previous frame section, predicting a harmonic frequency of a current frame section that is to be encoded by using a harmonic frequency of the previous frame section; and generating a residual signal by using a difference between the predicted harmonic frequency and an actual harmonic frequency of the current frame section.

The predicting of the harmonic frequency of the current frame section may include: calculating an amount of fundamental frequency change by using a fundamental frequency of the sinusoid of the current frame section and a fundamental frequency of the sinusoid of the previous frame section; and predicting a frequency of an n-th harmonic of the current frame section by using an n-th harmonic frequency of the previous frame section and the amount of fundamental frequency change, where n is an integer equal to or greater than 2. The predicting of the frequency of the n-th harmonic of the current frame section may include: predicting the frequency of the n-th harmonic of the previous frame section by multiplying a fundamental frequency of the sinusoid of the previous frame section by n; and determining a sinusoid, which has a frequency in a predetermined range with the predicted frequency of the n-th harmonic of the previous frame section, in the sinusoid of the previous frame section as the n-th harmonic of the previous frame section, and extracting the determined n-th harmonic. The predicting of the frequency of the n-th harmonic of the current frame section may further include predicting a value, which is obtained by adding the amount of the fundamental frequency change multiplied by n and the frequency of the n-th harmonic of the previous frame section, as the frequency of the n-th harmonic of the current frame section. The method further includes: encoding the amount of the fundamental frequency change; and encoding the residual signal. The method further includes, when the harmonics do not exist in the sinusoid of the previous frame section, encoding an actual frequency of the sinusoid of the current frame section. The method further includes encoding a phase and amplitude of the sinusoid of the current frame section.

According to another aspect of the present invention, there is provided a method of decoding a media signal, comprising a plurality of frames, the method including: when harmonics exist in a sinusoid of a previous frame section, predicting a harmonic frequency of a current frame section, that is to be decoded, by using a harmonic frequency of the previous frame section; and acquiring an actual harmonic frequency of the current frame section by using the predicted harmonic frequency.

According to another aspect of the present invention, there is provided an apparatus for encoding a media signal, comprising a plurality of frames, the apparatus including: a parameter predictor, when harmonics exist in a sinusoid of a previous frame section, predicting a harmonic frequency of a current frame section that is to be encoded by using a harmonic frequency of the previous frame section; and a residual signal generator generating a residual signal by using a difference between the predicted frequency and an actual harmonic frequency of the current frame section.

According to another aspect of the present invention, there is provided an apparatus for decoding a media signal, comprising a plurality of frames, the apparatus including: a parameter predictor, when harmonics exist in a sinusoid of a previous frame section, predicting a harmonic frequency of a current frame section, that is to be decoded, by using a harmonic frequency of the previous frame section; a residual signal extractor extracting a residual signal, which is a difference between the predicted frequency and an actual harmonic frequency of the current frame section, from the media signal; and a parameter restorer, which acquires a harmonic frequency of the current frame section by using the predicted frequency and the residual signal.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating a media signal parametric encoding apparatus according to an embodiment of the present invention;

FIG. 2 is a diagram illustrating in detail a residual signal processor of the media signal parametric encoding apparatus illustrated in FIG. 1;

FIG. 3 is a diagram illustrating a media signal parametric decoding apparatus according to an embodiment of the present invention;

FIG. 4 illustrates a technical aspect of the present invention in a graph;

FIG. 5 is a flowchart illustrating a media signal parametric encoding method according to an embodiment of the present invention; and

FIG. 6 is a flowchart illustrating a method of predicting a harmonic frequency of a current frame section by using a harmonic frequency of a previous frame section according to an embodiment of the present invention.

### DETAILED DESCRIPTION OF THE INVENTION

The present invention will now be described more fully with reference to the accompanying drawings, in which exemplary embodiments of the invention are shown.

In the present invention, a media signal includes an audio signal, a video signal, and other kinds of data. Hereinafter, an audio signal will be described as an example of the media signal, but the media signal is not limited thereto.

In the case of an audio signal, a signal generated from a sound source forms a complex tone, formed of a fundamental tone and harmonics, according to effects of characteristics of a medium, and reflection, refraction, diffraction, and resonance of a signal while sound is being transmitted. Harmonic coding uses a method of forming such a complex tone. Harmonic coding is a signal processing technique, which assumes an input signal to be a combination of a fundamental frequency and harmonic frequencies and performs modeling of the input signal. The harmonic coding can improve a compression rate by parameterizing a sinusoid extracted as above before performing coding. According to the present invention, signal compression/restoration is improved by combining the harmonic coding and parametric coding, and simultaneously transmitting information about a residual component, which causes distortion of a signal.

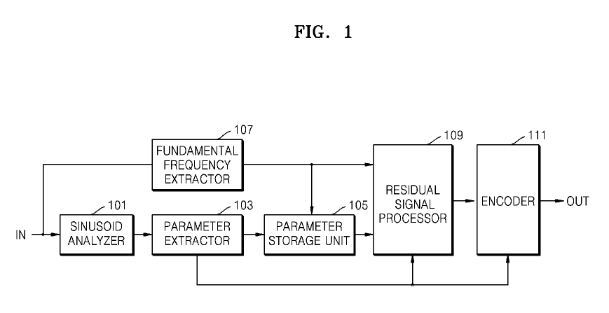

FIG. 1 is a diagram illustrating a media signal parametric encoding apparatus according to an embodiment of the present invention. Referring to FIG. 1, the media signal parametric encoding apparatus includes a sinusoidal analyzer 101, a parameter extractor 103, a parameter storage unit 105, a fundamental frequency extractor 107, a residual signal processor 109, and an encoder 111. The sinusoidal analyzer 101 divides an inputted media signal in time units, such as segments or frames, and analyzes and extracts a sinusoid of the inputted media signal according to each time section. The sinusoidal analyzer 101 analyzes the sinusoid by using a method of extracting a peak value of a frequency domain, a method of using interpolation considering a characteristic of an analysis window, a method of using a high-resolution fast Fourier transformation (FFT) which uses differentiation of a signal, or the like. The sinusoidal analyzer 101 transmits the extracted sinusoid to the parameter extractor 103. The parameter extractor 103 extracts a phase, the amplitude, and a frequency of the sinusoid according to each time section. The parameter storage unit 105 stores the parameter extracted from the parameter extractor 103. Since a harmonic frequency of a current frame section are predicted from a harmonic frequency of an adjacent frame section by using similar characteristics of the adjacent frames of the media signal, the parameter storage unit 105 can only store the frequency from among the phase, amplitude, and frequency of the sinusoid extracted according to each time section. A frequency of a sinusoid includes a fundamental frequency (f₀) and a harmonic frequency, and also includes a frequency of a sinusoid that is not separated as a harmonic component from a media signal. A periodic repetitive waveform, which is not a sinusoid, is decomposed into a sinusoid having a fundamental frequency and a wave having a frequency of an integral multiple of a sinusoid. Here, waves forming the repetitive waveform, other than a fundamental waveform, are called harmonics. When n is an integral equal to or greater than 2, a harmonic, wherein the harmonic's frequency is n times the fundamental frequency, is called an n-th harmonic, and a frequency of the n-th harmonic is denoted as fₙ.

The parameter extractor 103 transmits the parameter, such as the phase and the amplitude, excluding the frequency of the sinusoid to the encoder 111. The fundamental frequency extractor 107 extracts the fundamental frequency from the inputted media signal. The fundamental frequency extractor 107 may extract the fundamental frequency by using various algorithms, such as a method of using a convolution, a method of using a peak value of a frequency, and a method of using a time shift window. The fundamental frequency extractor 107 transmits the extracted fundamental frequency to the residual signal processor 109.

The residual signal processor 109 calculates a difference value between a fundamental frequency of a sinusoid of a previous frame section pre-stored in the parameter storage unit 105 and a fundamental frequency of a sinusoid of the current frame section. The residual signal processor 109 predicts a parameter of the current frame section by using the amount of fundamental frequency change (Δf₀) and the parameter of the previous frame section pre-stored in the parameter storage unit 105. The residual signal processor 109 generates a residual signal by calculating a difference between a predicted parameter value and an actual parameter value, and transmits the generated residual signal to the encoder 111. The encoder 111 generates a bitstream by encoding the generated residual signal and the amount of fundamental frequency change (Δf₀), and transmits the bitstream to a media signal parametric decoding apparatus (not shown). The encoder 111 can also encode a parameter, besides the frequency received from the parameter extractor 103, and transmit the encoded parameter to the media signal parametric decoding apparatus.

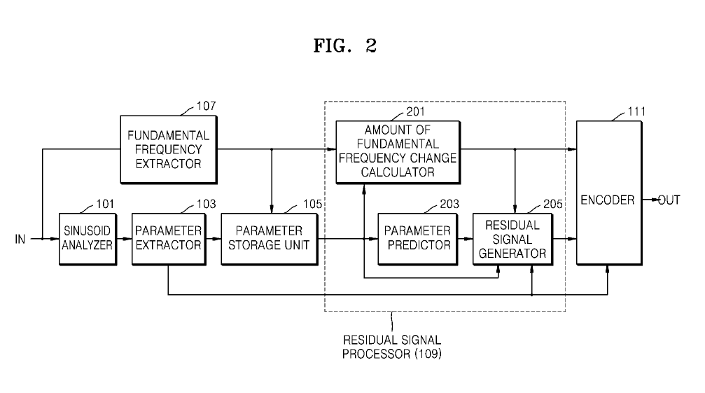

FIG. 2 is a diagram illustrating in detail the residual signal processor 109 of the media signal parametric encoding apparatus illustrated in FIG. 1. Referring to FIG. 2, the media signal parametric encoding apparatus includes a sinusoidal analyzer 101, a parameter extractor 103, a parameter storage unit 105, a fundamental frequency extractor 107, a residual signal processor 109, and an encoder 111. The sinusoidal analyzer 101 divides an input signal into a plurality of sinusoids. The parameter extractor 103 extracts parameters from the sinusoids divided by the sinusoidal analyzer 101, and transmits the parameters to the parameter storage unit 105 and the encoder 111. The parameter may include a phase, the amplitude, and a frequency. As described above, since the present invention uses a frequency as a parameter, the parameter extractor 103 transmits the frequency to the parameter storage unit 105 and the phase and the amplitude to the encoder 111. The fundamental frequency extractor 107 extracts a fundamental frequency of a sinusoid of a current frame section that is to be encoded from an inputted media signal, and transmits the extracted fundamental frequency to the parameter storage unit 105 and an amount of fundamental frequency change calculator 201 of the residual signal processor 109. The parameter storage unit 105 stores frequencies of sinusoids of each frame section received from the fundamental frequency extractor 107 and the parameter extractor 103. As described above, a frequency of a sinusoid includes a fundamental frequency (f₀) and frequencies (fₙ) of an n-th harmonic where n is equal to or grater than 2.

The residual signal processor 109 predicts a frequency of the sinusoid of the current frame section by using a frequency of a sinusoid of a previous frame section, and calculates a difference between the predicted frequency and the actual frequency. The residual signal processor 109 includes the amount of fundamental frequency change calculator 201, a parameter predictor 203, and a residual signal generator 205. The amount of fundamental frequency change calculator 201 extracts the fundamental frequency of the sinusoid of the previous frame section from the parameter storage unit 105, receives the fundamental frequency of the sinusoid of the current frame section that is to be encoded from the fundamental frequency extractor 107, and then calculates the amount of fundamental frequency change (Δf₀), which is a difference between the fundamental frequency of the sinusoid of the current frame section and the fundamental frequency of the sinusoid of the previous frame section. This can be expressed as Equation 1 below.

Δf₀=f_{0,cur}−f_{0,prev} Equation 1

Here, f_{0,cur} denotes the fundamental frequency of the sinusoid of the current frame section and f_{0,prev} denotes the fundamental frequency of the sinusoid of the previous frame section.

The amount of fundamental frequency change calculator 201 transmits the calculated amount of fundamental frequency change (Δf₀) to the parameter predictor 203 and the encoder 111. While restoring a media signal, a media signal parametric decoding apparatus (not shown) should determine a value of a fundamental frequency of the initial frame section. Accordingly, the fundamental frequency extractor 107 transmits the value of the fundamental frequency of the initial frame section to the encoder 111, and the encoder 111 transmits the value to the media signal parametric decoding apparatus after encoding the value. The fundamental frequency extractor 107 can transmit the fundamental frequency of the current frame section to the encoder 111 even when the current frame is not the initial frame. If a user does not reproduce the media signal from the beginning, the media signal parametric decoding apparatus starts reproduction from a point that the user wants to reproduce, and thus a fundamental frequency of a frame that starts the reproduction should be determined. Accordingly, the media signal parametric encoding apparatus transmits a fundamental frequency of a frame in a uniform interval or a random interval to the media signal parametric decoding apparatus.

The parameter predictor 203 predicts a harmonic frequency of the current frame section by using harmonics of the sinusoid of the previous frame section. Accordingly, the parameter predictor 203 extracts a frequency of the sinusoid of the previous frame section pre-stored in the parameter storage unit 105. The parameter predictor 203 can predict harmonics of the previous frame section by integrally multiplying the extracted fundamental frequency of the sinusoid of the previous frame section. This can be expressed as Equation 2 below.

f_{n,prev}_{ₑₛₜ}=n*f_{0,prev} Equation 2

Here, f_{n,prev}_{ₑₛₜ} denotes a predicted frequency of an n-th harmonic of the sinusoid of the previous frame section.

The parameter predictor 203 extracts the pre-stored frequency of the sinusoid of the previous frame section from the parameter storage unit 105, and the extracted sinusoid may or may not comprise harmonics. As described above, since harmonics of a sinusoid are frequencies of an integral multiple of a fundamental frequency, the parameter predictor 203 predicts an integral multiple of the fundamental frequency (f₀) of the sinusoid of the previous frame section as the harmonics.

The parameter predictor 203 extracts a sinusoid, which has a frequency of the predicted harmonics, from among the sinusoids extracted from the parameter storage unit 105. Accordingly, the parameter predictor 203 may determine a sinusoid, which has a frequency wherein a difference with the frequency of the predicted harmonics is within a predetermined range, as comprising the harmonics. This can be expressed as Equation 3 below.

|f_{n,prev}_{ₑₛₜ}−f_{n,prev}|<a Equation 3

Here, a denotes the predetermined range.

The parameter predictor 203 determines a sinusoid that satisfies Equation 3 from among the sinusoids extracted from the parameter storage unit 105 as the harmonics.

The parameter predictor 105 can predict the harmonics of the current frame section by using the sinusoid that is determined as the harmonics of the previous frame section. The parameter predictor 203 can predict the harmonics of the current frame section by using a tracking method, which searches for a signal having the highest connection possibility by using information about the amplitudes, frequencies, and phases of frames. The parameter predictor 203 predicts a frequency of an n-th harmonic of the current frame section by adding a frequency of an n-th harmonic of the previous frame section and the amount of fundamental frequency change, which is multiplied by n, wherein n is an integral. Since harmonics of a sinusoid are frequencies of an integral multiple of a fundamental frequency, when a difference between the fundamental frequencies of the sinusoids of the previous frame section and the current frame section is Δf₀, a difference between the frequencies of the n-th harmonic of the previous frame section and the current frame section is n*Δf₀. This can be expressed as Equation 4 below.

f_{n,cur}_{ₑₛₜ}=f_{n,prev}+n*Δf₀ Equation 4

Here, f_{n,cur}_{ₑₛₜ} is the frequency of the n-th harmonic predicted in the current frame section.

The parameter predictor 203 transmits the predicted harmonic frequency of the current frame section to the residual signal generator 205. The residual signal generator 205 receives the predicted harmonic frequency of the current frame section from the parameter predictor 203 and receives the actual harmonic frequency of the current frame section from the parameter extractor 103. The residual signal generator 205 calculates a difference between the predicted harmonic frequency of the current frame section and the actual harmonic frequency of the current frame section as shown in Equation 5 below. Then, the residual signal generator 205 generates a residual signal by using such a difference, and transmits the residual signal to the encoder 111.

residual=f_{n,cur}−f_{n,cur}_{ₑₛₜ} Equation 5

Instead of encoding all actual frequencies of the harmonics of the current frame section, the media signal parametric encoding apparatus only encodes the difference between the harmonic frequency of the current frame section and the harmonic frequency of the previous frame section. Accordingly, a bit rate decreases and thus compression efficiency and transmission efficiency increase. Also, since the harmonics of the current frame section are determined based on whether the harmonics exist in the sinusoid of the previous frame section, whether a sinusoid of each parameter comprises harmonics does not have to be separately indicated.

The encoder 111 performs entropy encoding of the amount of fundamental frequency change (Δf₀) received from the amount of fundamental frequency change calculator 201 and the residual signal received from the residual signal generator 205. An entropy encoding method performs compression using a statistic characteristic of a generated signal, and includes various methods, such as a run-length encoding method, a dictionary encoding method, a variable length coding (VLC) method, and an arithmetic coding method.

When a sinusoid that satisfies Equation 3 does not exist, i.e. when a sinusoid that is determined to comprise harmonics satisfying Equation 3 does not exist from among the sinusoids of the previous frame section, the parameter predictor 203 cannot transmit the predicted harmonic frequency of the current frame section to the residual signal generator 205. Accordingly, the residual signal generator 205 does not generate a residual signal. When the encoder 111 does not receive the residual signal from the residual signal generator 205, the encoder 111 encodes the frequency of the sinusoid of the current frame section received from the parameter extractor 103. The encoder 111 transmits the encoded signal to the media signal parametric decoding apparatus (not shown).

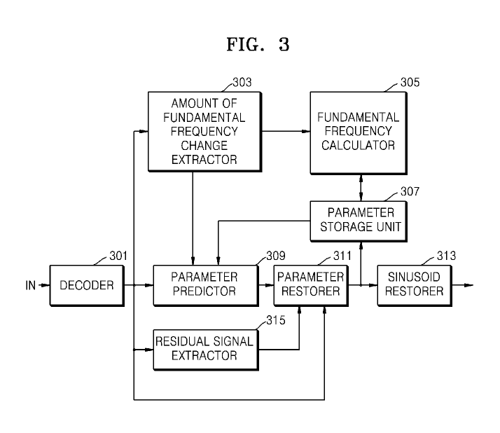

FIG. 3 is a diagram illustrating a media signal parametric decoding apparatus according to an embodiment of the present invention. Referring to FIG. 3 the media signal parametric decoding apparatus includes a decoder 301, an amount of fundamental frequency change extractor 303, a fundamental frequency calculator 305, a parameter storage unit 307, a parameter predictor 309, a parameter restorer 311, a sinusoid restorer 313, and a residual signal extractor 315. The decoder 301 receives an encoded media signal from a media signal parametric encoding apparatus, parses the media signal according to each signal, and performs entropy encoding of the parsed media signal.

The amount of fundamental frequency change extractor 303 extracts an amount of fundamental frequency change (Δf₀) in order to calculate a frequency of a sinusoid of a current frame section. The amount of fundamental frequency change extractor 303 transmits the extracted amount of fundamental frequency change to the fundamental frequency calculator 305. The fundamental frequency calculator 305 extracts a pre-stored frequency of a sinusoid of a previous frame section from the parameter storage unit 307. The fundamental frequency calculator 305 extracts a fundamental frequency of the sinusoid of the previous frame section from the parameter storage unit 307, and calculates a fundamental frequency of the sinusoid of the current frame section that is to be decoded by using the extracted fundamental frequency of the sinusoid of the previous frame section and the amount of fundamental frequency change received from the amount of fundamental frequency change extractor 303. The fundamental frequency calculator 305 can calculate the fundamental frequency of the sinusoid of the current frame section using an equation, f_{0,cur}=f_{0,prev}+Δf₀, based on Equation 1 above, which uses received Δf₀ and the fundamental frequency of the sinusoid of the previous frame section pre-stored in the parameter storage unit 307.

The parameter storage unit 307 stores parameters of sinusoids. The parameter storage unit 307 stores the decoded frequency of the sinusoid of the previous frame section and transmits the decoded frequency when the parameter predictor 309 or the fundamental frequency calculator 305 requires using the frequency of the sinusoid of the previous frame section. The parameter storage unit 307 also stores the fundamental frequency of the current frame section calculated by the fundamental frequency calculator 305, and stores the harmonic frequency of the current frame section restored by the parameter restorer 311.

The parameter predictor 309 performs the same functions as the parameter predictor 203 illustrated in FIG. 2. When harmonics exist in the sinusoid of the previous frame section, the parameter predictor 309 may predict a harmonic frequency of the current frame section by using a harmonic frequency of the previous frame section. Accordingly, the parameter predictor 309 determines whether the harmonics exist in the sinusoid of the previous frame section decoded by the decoder 301 and stored in the parameter storage unit 307. The parameter predictor 309 can predict the harmonics of the previous frame section, which have frequencies of an integral multiple of the fundamental frequency, by integrally multiplying the fundamental frequency of the sinusoid of the previous frame section extracted from the parameter storage unit 307 using Equation 2.

The parameter predictor 309 extracts a sinusoid having a frequency of the predicted harmonics from among sinusoids of the previous frame section extracted from the parameter storage unit 307. Using Equation 3, the parameter predictor 309 can determine a sinusoid, which has a frequency wherein its difference with the predicted harmonic frequency obtained by Equation 2 is within a predetermined range, as comprising the harmonics. The parameter predictor 309 can predict the harmonics of the current frame section by using the sinusoid that is determined as the harmonics of the previous frame section. The parameter predictor 309 predicts a frequency of an n-th harmonic of the current frame section by adding a frequency of an n-th harmonic of the previous frame section and the amount of fundamental frequency change, which is multiplied by n, by using Equation 4. The parameter predictor 309 transmits the predicted harmonic frequency of the current frame section to the parameter restorer 311.

The residual signal extractor 315 extracts a residual signal generated by a media signal parametric encoding device using Equation 5 from the decoded media signal. As described above, the residual signal is a difference between the predicted harmonic frequency of the current frame section and the actual harmonic frequency of the current frame section. The residual signal extractor 315 transmits the extracted residual signal to the parameter restorer 311.

The parameter restorer 311 calculates the actual harmonic frequency of the current frame section by using the predicted harmonic frequency of the current frame section received from the parameter predictor 309 and the residual signal received from the residual signal extractor 315, by using Equation 5. The parameter restorer 311 transmits the restored harmonic frequency of the current frame section to the sinusoid restorer 313 and the parameter storage unit 307. The parameter storage unit 307 stores the harmonic frequency of the current frame section received from the parameter restorer 311.

When the harmonics do not exist in the sinusoid of the previous frame section pre-stored in the parameter storage unit 307, the parameter predictor 309 cannot obtain the harmonics of the sinusoid of the current frame section by using the residual signal. In this case, the parameter restorer 311 extracts the parameter of the sinusoid of the current frame section decoded by the decoder 301.

When the harmonics exist in the previous frame section stored in the parameter storage unit 307, the sinusoid restorer 313 restores the sinusoid by using the parameter of the frequency of the sinusoid of the current frame section restored using the residual signal, and when the harmonics do not exist in the previous frame section stored in the parameter storage unit 307, the sinusoid restorer 313 restores the sinusoid by using the parameter extracted by the parameter restorer 311.

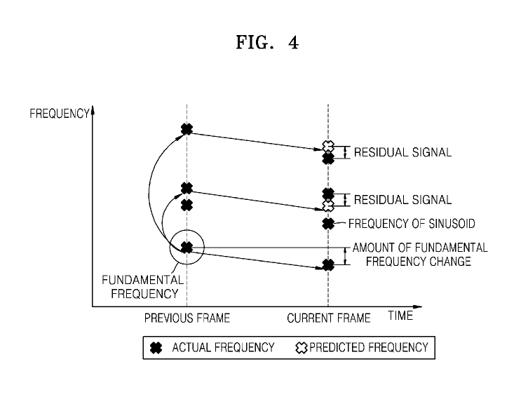

FIG. 4 illustrates a technical aspect of the present invention in a graph. The horizontal axis denotes time and the vertical axis denotes a frequency. A media signal can be divided into time domains, such as segments and frames, and each time domain is divided into a plurality of sinusoids. The parameter predictors 203 and 309 of FIGS. 2 and 3 predict a frequency of a sinusoid of a current frame section by using a frequency of a sinusoid of a previous frame section. The sinusoid of the previous frame section may include a fundamental frequency, and a frequency of an integral multiple of the fundamental frequency or a frequency of a non-integral multiple of the fundamental frequency. The parameter predictors 203 and 309 predict a harmonic frequency of the previous frame section by integrally multiplying the fundamental frequency of the sinusoid of the previous frame section. The parameter predictors 203 and 309 determine a sinusoid having a frequency within a predetermined range with the predicted frequency from among the sinusoid of the previous frame section as comprising the harmonics. In FIG. 4, the second top frequency, from among the frequencies of the sinusoid of the previous frame section, is assumed to be outside the predetermined range with the integral multiple of the fundamental frequency. The parameter predictors 203 and 309 determine a frequency, excluding the second top frequency, from among the frequencies of the sinusoid of the previous frame section as a harmonic frequency.

The parameter predictors 203 and 309 can predict a harmonic frequency of the current frame section by adding the harmonic frequency of the previous frame section and the amount of fundamental frequency change. When a difference between the fundamental frequencies of the sinusoids of the previous frame section and the current frame section is Δf₀, a difference between frequencies of an n-th harmonic of the previous frame section and the current frame section is n*Δf₀. The parameter predictors 203 and 309 predict the frequency of the n-th harmonic of the current frame section by adding the frequency of the n-th harmonic of the previous frame section and n*Δf₀. In crosses illustrated in the current frame section in FIG. 4, a white cross denotes a frequency of the current frame section predicted from the frequency of the previous frame section and a black cross denotes an actual harmonic frequency of the current frame section.

The parameter predictor 203 extracts and transmits the predicted harmonic frequency of the current frame section to the residual signal generator 205. The residual signal generator 205 generates a residual signal by using a difference between the predicted harmonic frequency of the current frame section received from the parameter predictor 203 and the actual harmonic frequency of the current frame section. Then, the encoder 111 encodes the residual signal and the amount of fundamental frequency change.

When a sinusoid that is determined to comprise harmonics does not exist in the sinusoid of the previous frame section, the parameter predictor 203 cannot transmit the predicted harmonic frequency of the current frame section to the residual signal generator 205. In this case, the residual signal generator 205 encodes the actual frequency of the sinusoid of the current frame section.

The parameter predictor 309 of the media signal parametric decoding apparatus transmits the predicted harmonic frequency of the current frame section to the parameter restorer 311. The residual signal extractor 315 extracts the residual signal from among the media signal inputted to the media signal parametric decoding apparatus, and transmits the extracted residual signal to the parameter restorer 311. The parameter restorer 311 restores the parameter of the actual frequency of the current frame section by adding the predicted harmonic frequency of the current frame section and the residual signal. When the sinusoid that is determined to comprise the harmonics does not exist in the sinusoid of the previous frame section, the media signal parametric decoding apparatus extracts the actual frequency of the sinusoid of the current frame section from the media signal and restores the sinusoid by using the extracted actual frequency.

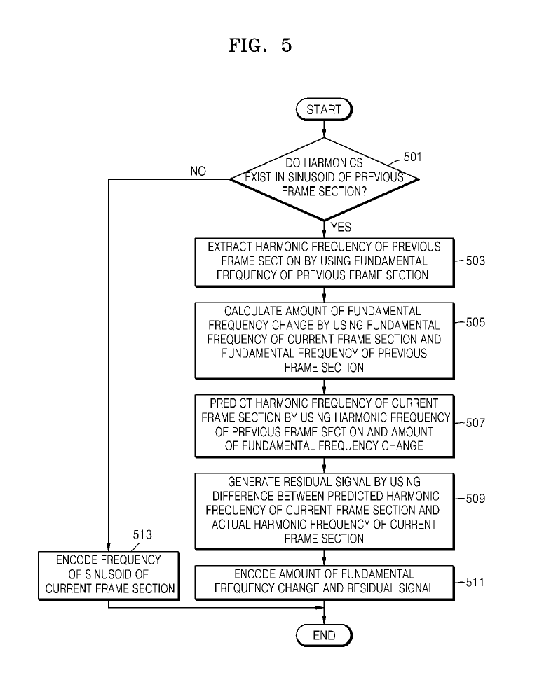

FIG. 5 is a flowchart illustrating a media signal parametric encoding method according to an embodiment of the present invention. A media signal parametric encoding apparatus divides a media signal into frames and extracts a sinusoid from each frame. The media signal parametric encoding apparatus determines whether harmonics comprising frequencies of an integral multiple of a fundamental frequency of a previous frame section exist in pre-stored frequencies of a sinusoid of the previous frame section in operation 501 in order to predict a frequency of a current frame section that is to be encoded. When the harmonics exist, the media signal parametric encoding apparatus extracts a harmonic frequency in operation 503. The media signal parametric encoding apparatus calculates an amount of fundamental frequency change in operation 505 by using a fundamental frequency of the current frame section and a fundamental frequency of the sinusoid of the previous frame section. The media signal parametric encoding apparatus predicts the harmonic frequency of the current frame section in operation 507 by using the harmonic frequency of the previous frame section and the amount of fundamental frequency change obtained in operations 503 and 505. The media signal parametric encoding apparatus generates a residual signal in operation 509 by using a difference between the predicted harmonic frequency of the current frame section and an actual harmonic frequency of the current frame section. In operation 511, the media signal parametric encoding apparatus encodes the amount of fundamental frequency change and the generated residual signal. When the harmonics that are to be used to predict the frequency of the sinusoid of the current frame section do not exist in the sinusoid of the previous frame section, the media signal parametric encoding apparatus encodes the frequency of the sinusoid of the current frame section in operation 513.

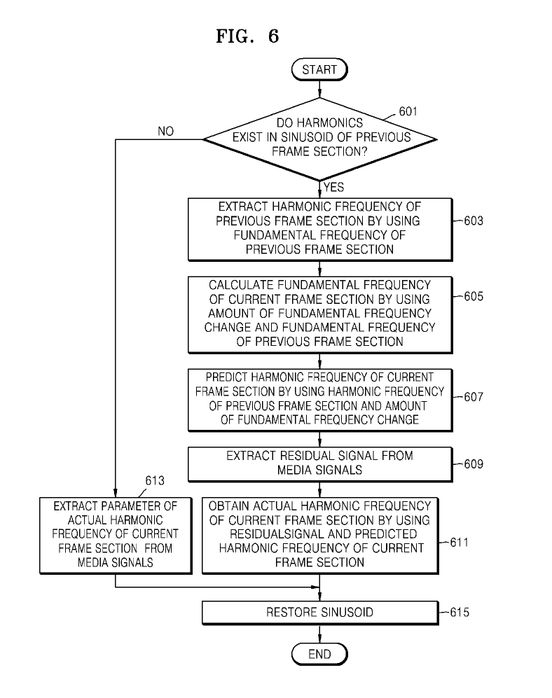

FIG. 6 is a flowchart illustrating a method of predicting a harmonic frequency of a current frame section by using a harmonic frequency of a previous frame section according to an embodiment of the present invention. A media signal parametric decoding apparatus parses media signals received from a media signal parametric encoding apparatus according to types of the media signals, and decodes each of the parsed media signals. The media signal parametric decoding apparatus determines whether harmonics exist in a sinusoid of a previous frame section in operation 601 in order to restore a parameter of a sinusoid of a current frame section. When the harmonics exist in the sinusoid of the previous frame section, the media signal parametric decoding apparatus extracts a harmonic frequency of the previous frame section in operation 603 by using a fundamental frequency of the previous frame section. The media signal parametric decoding apparatus extracts an amount of fundamental frequency change from the media signals, and obtains the fundamental frequency of the current frame section by using the pre-stored fundamental frequency of the previous frame section in operation 605. As described above, the fundamental frequency of the current frame section may be received in a uniform interval or a random interval from the media signal parametric encoding apparatus. In this case, the media signal parametric decoding apparatus can extract the fundamental frequency of the current frame section from the media signals. The media signal parametric decoding apparatus predicts a harmonic frequency of the current frame section by using a harmonic frequency of the previous frame section and the amount of fundamental frequency change in operation 607. The media signal parametric decoding apparatus extracts a residual signal from the media signals in operation 609. The media signal parametric decoding apparatus obtains a parameter of an actual harmonic frequency of the current frame section in operation 611 by using the residual signal and the predicted harmonic frequency of the current frame section. When the harmonics do not exist in the sinusoid of the previous frame section, the media signal parametric decoding apparatus extracts a parameter of the actual harmonic frequency of the current frame section from the media signals in operation 613. The media signal parametric decoding apparatus restores the original sinusoid in operation 615 by using the parameter.

According to the method and apparatus for encoding/decoding a media signal of the present invention can improve signal fidelity by minimizing distortion of the media signal, by parameterizing and transmitting a changed component in consideration of a signal change between frames according to a change of time.

Also, the method and apparatus according to the present invention can encode/decode a media signal, into a smaller size, by encoding a difference between harmonics of a certain frame section and an adjacent frame section, without encoding all harmonics of the certain frame section of the media signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a media signal comprising a plurality of frames, the method comprising:
if a harmonic is in a sinusoid of a previous frame section, predicting a harmonic frequency of a current frame section that is to be encoded, by using a harmonic frequency of the previous frame section; and
determining a difference between the predicted harmonic frequency of the current frame section and an actual harmonic frequency of the current frame section to generate a residual signal.

2. The method of claim 1, wherein the predicting of the harmonic frequency of the current frame section comprises:
calculating an amount of fundamental frequency change by using a fundamental frequency of a sinusoid of the current frame section and a fundamental frequency of the sinusoid of the previous frame section; and
predicting a frequency of an n-th harmonic of the current frame section by using a frequency of an n-th harmonic of the previous frame section and the amount of fundamental frequency change, where n is an integer equal to or greater than 2.

3. The method of claim 2, wherein the predicting of the frequency of the n-th harmonic of the current frame section comprises:
predicting the frequency of the n-th harmonic of the previous frame section by multiplying the fundamental frequency of the sinusoid of the previous frame section by n; and
determining a sinusoid which has a frequency in a range of the predicted frequency of the n-th harmonic of the previous frame section, in the sinusoid of the previous frame section as the n-th harmonic of the previous frame section, and extracting the determined n-th harmonic.

4. The method of claim 3, wherein the predicting of the frequency of the n-th harmonic of the current frame section further comprises predicting a value which is obtained by adding the amount of the fundamental frequency change multiplied by n and the frequency of the n-th harmonic of the previous frame section, as the frequency of the n-th harmonic of the current frame section.

5. The method of claim 2, further comprising
encoding the amount of the fundamental frequency change; and
encoding the residual signal.

6. The method of claim 1, further comprising, if the sinusoid of the previous frame section does not include any harmonics, encoding an actual frequency of a sinusoid of the current frame section.

7. The method of claim 1, further comprising encoding a phase and an amplitude of the sinusoid of the current frame section.

8. A method of decoding a media signal, comprising a plurality of frames, the method comprising:
if a harmonic is in a sinusoid of a previous frame section, predicting a harmonic frequency of a current frame section that is to be decoded, by using a harmonic frequency of the previous frame section; and
generating an actual harmonic frequency of the current frame section by using the predicted harmonic frequency.

9. The method of claim 8, wherein the generating of the actual harmonic frequency of the current frame section comprises:
determining a difference between the predicted frequency of the current frame section and an actual harmonic frequency of the current frame section, to extract a residual signal from the media signal; and
generating the harmonic frequency of the current frame section by using the predicted harmonic frequency and the residual signal.

10. The method of claim 8, wherein the predicting of the harmonic frequency of the current frame section comprises:
extracting an amount of fundamental frequency change which is a difference between a fundamental frequency of a sinusoid of the current frame section and a fundamental frequency of the sinusoid of the previous frame section, from the media signal; and
predicting a frequency of an n-th harmonic of the current frame section by using a frequency of an n-th harmonic of the previous frame section and the amount of fundamental frequency change, where n is an integer equal to or greater than 2.

11. The method of claim 10, wherein the predicting of the frequency of the n-th harmonic of the current frame section comprises:
predicting the frequency of the n-th harmonic of the previous frame section by multiplying the fundamental frequency of the sinusoid of the previous frame section by n; and
determining a sinusoid which has a harmonic frequency in a range of the predicted frequency of the n-th harmonic of the previous frame section, in the stored sinusoid of the previous frame section as the n-th harmonic of the previous frame section, and extracting the determined n-th harmonic.

12. The method of claim 10, wherein the predicting of the frequency of the n-th harmonic of the current frame section further comprises predicting a value which is obtained by adding the amount of the fundamental frequency change multiplied by n and the frequency of the n-th harmonic of the previous frame section, as the frequency of the n-th harmonic of the current frame section.

13. The method of claim 8, further comprising if the sinusoid of the previous frame section does not include any harmonics, decoding the actual frequency of a sinusoid of the current frame section.

14. The method of claim 8, further comprising decoding a phase and amplitude of a fundamental and the harmonics of the sinusoid of the current frame section.

15. An apparatus for encoding a media signal comprising a plurality of frames, the apparatus comprising:
a predictor which, if a harmonic is in a sinusoid of a previous frame section, predicts a harmonic frequency of a current frame section that is to be encoded, by using a harmonic frequency of the previous frame section; and
a second generator which generates a residual signal by using a difference between the predicted harmonic frequency of the current frame section and an actual harmonic frequency of the current frame section.

16. The apparatus of claim 15, further comprising a calculator which calculates an amount of fundamental frequency change by using a fundamental frequency of a sinusoid of the current frame section and a fundamental frequency of the sinusoid of the previous frame section,
wherein the predictor predicts a frequency of an n-th harmonic of the current frame section by using a frequency of an n-th harmonic of the previous frame section and the amount of fundamental frequency change, where n is an integer equal to or greater than 2.

17. The apparatus of claim 16, wherein the predictor predicts the frequency of the n-th harmonic of the previous frame section by multiplying the fundamental frequency of the sinusoid of the previous frame section by n, determines a sinusoid which has a frequency in a range of the predicted frequency of the n-th harmonic of the previous frame section, in the sinusoid of the previous frame section as the n-th harmonic of the previous frame section, and extracts the determined n-th harmonic.

18. The apparatus of claim 17, wherein the predictor predicts a value which is obtained by adding the amount of the fundamental frequency change multiplied by n and the frequency of the n-th harmonic of the previous frame section, as the frequency of the n-th harmonic of the current frame section.

19. The apparatus of claim 15, further comprising an encoder, which encodes the amount of the fundamental frequency change and the residual signal.

20. The apparatus of claim 19, wherein the encoder, the sinusoid of the previous frame section does not include any harmonics, encodes an actual frequency of a sinusoid of the current frame section.

21. An apparatus for decoding a media signal, comprising a plurality of frames, the apparatus comprising:
a predictor which, if a harmonic is in a sinusoid of a previous frame section, predicts a harmonic frequency of a current frame section that is to be decoded, by using a harmonic frequency of the previous frame section;
a first extractor which extracts a residual signal which is a difference between the predicted harmonic frequency of the current frame section and an actual harmonic frequency of the current frame section, from the media signal; and
a restorer which generates a harmonic frequency of the current frame section by using the predicted harmonic frequency of the current frame section and the residual signal.

22. The apparatus of claim 21, further comprising a second extractor which extracts an amount of fundamental frequency change, which is a difference between a fundamental frequency of a sinusoid of the current frame section and a fundamental frequency of the sinusoid of the previous frame section, from the media signal,
wherein the predictor predicts a frequency of an n-th harmonic of the current frame section by using a frequency of an n-th harmonic of the previous frame section and the amount of fundamental frequency change, where n is an integer equal to or greater than 2.

23. The apparatus of claim 22, wherein the predictor predicts a frequency of the n-th harmonic of the previous frame section by multiplying the fundamental frequency of the sinusoid of the previous frame section by n, determines a sinusoid which has a frequency in a range of the predicted frequency of the n-th harmonic of the previous frame section, in the sinusoid of the previous frame section as the n-th harmonic of the previous frame section, and extracting the determined n-th harmonic.

24. The apparatus of claim 22, wherein the predictor predicts a value which is obtained by adding the amount of the fundamental frequency change multiplied by n and the frequency of the n-th harmonic of the previous frame section, as the frequency of the n-th harmonic of the current frame section.
